(19) United States
(12) Patent Application Publication
(10) Pub. No.: US 2026/0303942 A1
(43) Pub. Date: Oct. 1, 2026

(54) CONTEXTUAL CAMERA LAUNCHING

(71) Applicant: Motorola Mobility LLC, Chicago, IL (US)

(72) Inventors: Amit Kumar Agrawal, Bangalore (IN); Marcello Zuffo, Chicago, IL (US); Rahul Bharat Desai, Hoffman Estates, IL (US)

(73) Assignee: Motorola Mobility LLC, Chicago, IL (US)

(21) Appl. No.: 19/089,931

(22) Filed: Mar. 25, 2025

(51) Int. Cl. H04N 23/57; G06F 3/01; G06F 9/451; G06V 10/764

(52) U.S. Cl. CPC H04N 23/57; G06F 3/017; G06F 9/451; G06V 10/764

(57) ABSTRACT

In aspects of contextual invocation of a camera in a service mode, a mobile device determines a context associated with the mobile device. The mobile device receives user input to launch a camera functionality. Based at least in part on the context, the mobile device launches a device application functionality to utilize an image or video obtained by the camera functionality.

### BACKGROUND

Mobile devices, such as cellular phones, smartphones, and tablet devices, have become a common part of our daily lives, offering various functionalities beyond traditional communication. These mobile devices often include high-quality cameras that users can employ for various purposes, such as capturing memories, documenting information, or interacting with digital services. For example, mobile device cameras can take photographs, record videos, scan documents, or read QR codes for different applications.

The integration of cameras with mobile applications has expanded how users interact with their devices and the world around them. Mobile applications can utilize device cameras for tasks such as visual search, augmented reality experiences, or facilitating transactions.

### BRIEF DESCRIPTION OF THE DRAWINGS

Implementations of the techniques for contextual camera launching are described with reference to the following Figures. The same numbers may be used throughout to reference like features and components shown in the Figures:

FIG. 1 illustrates an example communication system for contextual camera launching in accordance with one or more implementations as described herein.

FIG. 2 illustrates an example system in which aspects of contextual camera launching can be implemented in accordance with one or more implementations as described herein.

FIG. 3A illustrates a launch procedure for contextual camera launching within a messaging application in accordance with one or more implementations as described herein.

FIG. 3B illustrates a launch procedure for contextual camera launching based on detected items in accordance with one or more implementations as described herein.

FIG. 3C illustrates a launch procedure for contextual camera launching based on a QR code in accordance with one or more implementations as described herein.

FIG. 4 illustrates an example method for contextual launching of device applications in accordance with one or more implementations as described herein.

FIG. 5 illustrates an example method for training or optimizing a machine-learning model to implement techniques for contextual launching of device applications in accordance with one or more implementations as described herein.

FIG. 6 illustrates various components of an example device that may be used to implement the techniques for contextual camera launching as described herein.

### DETAILED DESCRIPTION

Implementations of techniques for contextual camera launching may be implemented as described herein. A mobile device, such as any wireless device, media device, mobile phone, flip phone, client device, tablet, computer, communication device, entertainment device, gaming device, media playback device, and/or any other type of electronic device, or a system of any combination of such devices, may be operable to perform techniques for contextual camera launching as described herein. For example, a mobile device implements a camera functionality that is contextually launched into a contextually appropriate application to capture images and videos. A mobile device includes a camera launch module in one or more implementations, which can implement aspects of the techniques described herein.

Mobile device cameras have become integral to modern communication, documentation, and digital interaction. The increasing prevalence of high-quality cameras in mobile devices is attributable to technological advancements, user demand for visual content creation, and the integration of cameras into various applications and services. These digital imaging capabilities offer numerous benefits, including instant visual communication, easy document scanning, and seamless interaction with visual-based services. As mobile applications continue to leverage camera functionality, mobile device cameras provide a versatile tool for capturing memories, sharing information, and interacting with the digital and physical world.

Conventional techniques for launching applications that utilize camera functionality on mobile devices may not provide efficient access to the right camera use for a given context. For example, users manually navigate through multiple apps or menus to find the appropriate application for their current camera task. This process is often time-consuming and may result in missed opportunities to capture fleeting moments or interact with time-sensitive visual elements like QR codes. Additionally, the ability to quickly switch between different camera-enabled applications based on context is limited in existing solutions, leading to a disjointed user experience and potential frustration when using the camera for various purposes.

As described herein, a mobile device implements techniques for providing contextual camera launching to provide convenient and efficient access to appropriate device applications or device application functionalities. The mobile device monitors the context associated with the device, including factors such as the current location, active applications, and visual elements captured by a camera functionality, e.g., an always-on camera. When a user initiates a camera launch action, the mobile device analyzes the current context to determine the appropriate application, application functionality, or camera mode to launch. This context-aware launching can include opening specific third-party applications ready to perform specific functionalities, activating particular camera modes within the default camera application, or launching multiple applications simultaneously to share captured images or videos.

The techniques described herein offer several advantages over conventional approaches for camera launching. By providing context-aware camera launching, the system helps prevent delays in accessing appropriate camera functionality, reducing the risk of missing important moments or opportunities for visual interaction. The contextual launch results in a more streamlined and efficient camera experience, particularly for users who frequently use their device's camera for various purposes. Additionally, the mobile device's ability to monitor context and learn from user behavior allows for increasingly accurate predictions of the desired camera functionality, improving efficiency and user satisfaction. This adaptive approach enables users to seamlessly integrate camera use into their daily activities, ultimately enhancing the overall utility of mobile device cameras compared to conventional techniques that rely on manual navigation and lack context awareness. In addition, the contextual launching potentially provides power savings as users consume less resources and display power performing the desired action.

Consider an example scenario where Maria often uses her smartphone's camera for various purposes throughout her day, from scanning documents at work to sharing food photos with friends and making mobile payments at stores. With conventional camera launching, she frequently fumbles through applications to find the right camera functionality, sometimes missing the moment she wanted to capture or causing delays in her transactions. These experiences highlight the limitations of conventional approaches to mobile device camera use.

However, users may have a more seamless and efficient experience with the contextual camera launching techniques described herein. For example, a system monitors the device's context and user patterns, providing quick access to the appropriate camera functionality. The described techniques allow users to effortlessly switch between camera-enabled applications based on their current activity and environment. The context-aware launching includes opening specific applications directly to their camera interfaces or activating particular modes within the default camera application. In this way, users more effectively integrate camera use into their daily activities, avoiding frustration and improving overall power efficiency by reducing wasted processing activities. The improved efficiency also provides computational efficiency to provide greater processor and memory bandwidth for other background or foreground tasks.

While features and concepts of the described techniques for contextual camera launching are implemented in various devices, systems, environments, and/or configurations, implementations of the techniques for contextual camera launching are described in the context of the following example devices, systems, and methods.

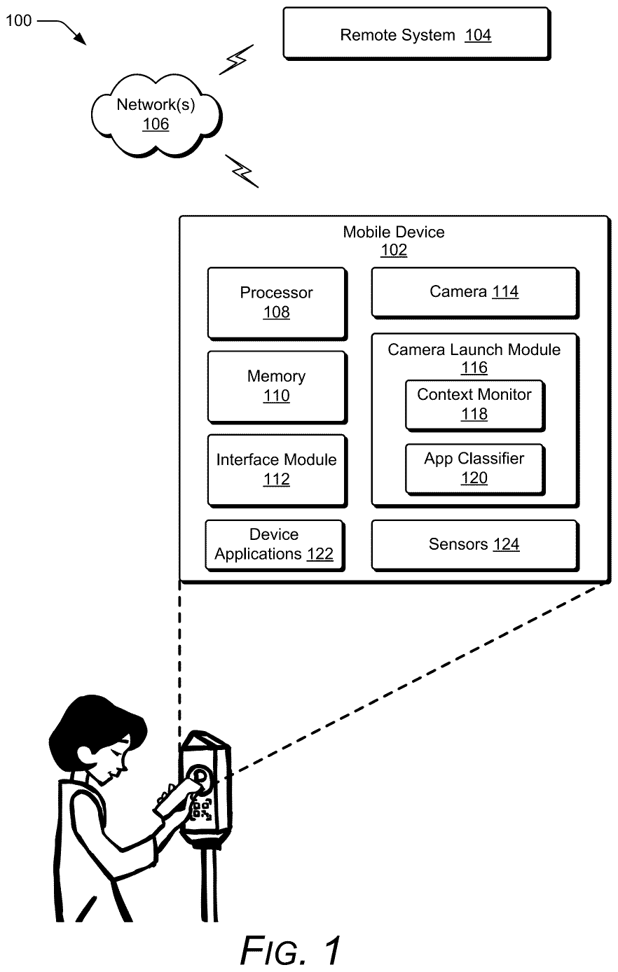

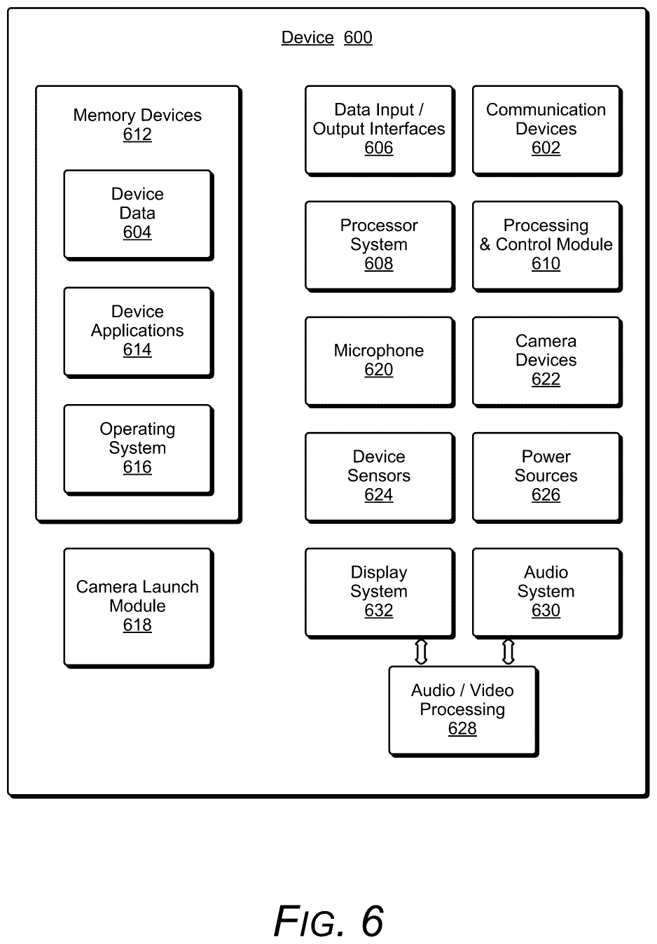

FIG. 1 illustrates an example communication system 100 for contextual camera launching in accordance with one or more implementations as described herein. The communication system 100 includes a mobile device 102 and a remote system 104, where the mobile device 102 and the remote system 104 are interconnectable via a network 106. The remote system 104 is remote from or independent of the mobile device 102 (e.g., in a physical location different from the mobile device 102, which is not collocated). The mobile device 102 and/or the remote system 104 range from a full-resource device with substantial memory and processor resources to a low-resource device with reduced memory and/or processing resources. Although in some instances, reference is made to a mobile device 102 and a remote system 104, respectively, in the singular, a mobile device 102 and a remote system 104 may also represent multiple different devices in some cases. The mobile device 102 and a remote system 104 include one or more features in addition to, or as an alternative, the features illustrated in the communication system 100. The mobile device 102 and the remote system 104 can be implemented in various ways and include various functionality, examples of which are discussed below with reference to the example device 600 of FIG. 6.

Examples of mobile device 102 include at least one of any wireless device, mobile device, smartphone, mobile phone, flip phone, client device, companion device, laptop, tablet, computing device, communication device, entertainment device, gaming device, media playback device, and/or any other type of computing or electronic device. In one or more implementations, the mobile device 102 and the remote system 104 include various radios for wireless communication (e.g., via the network 106). For example, the mobile device 102 and the remote system 104 include a Wi-Fi radio, a cellular radio, a Bluetooth (BT) and/or Bluetooth Low Energy (BLE) transceiver, a near-field communication (NFC) transceiver, and/or other device communication interfaces.

In some implementations, the devices, applications, modules, servers, and/or services described herein communicate via one or more networks 106, such as for data communication with the mobile device 102. The network 106 includes a wired and/or wireless network. The network 106 can be implemented using any network topology and/or communication protocol. The network 106 can be implemented as a combination of two or more networks, including IP-based networks, cellular networks, and/or the Internet. The network 106 can include mobile operator networks managed by a mobile network operator and/or other network operators, such as a communication service provider, mobile phone provider, and/or Internet service provider.

The mobile device 102 includes components, including a processor 108, a memory 110, and an interface module 112, as well as any number and combination of different components as further described with reference to the example device 600 shown in FIG. 6. The mobile device 102 also includes a camera 114 and a camera launch module 116 that includes a context monitor 118 and an application classifier 120. The processor 108 and memory 110 provide data processing capabilities and data storage for the mobile device 102.

The mobile device 102 includes various functionalities enabling the device to perform contextual camera launching, as described herein. In one or more examples, the interface module 112 represents functionality (e.g., logic and/or hardware) enabling the mobile device 102 to interconnect and interface with other devices (e.g., the remote system 104) and/or networks, such as the network 106. For example, the interface module 112 enables wireless and/or wired connectivity of the mobile device 102 to initiate camera launches, receive user inputs, and determine status information about the environment of the mobile device 102.

The mobile device 102 includes and implements various device applications 122, such as any type of messaging application, email application, video communication application, cellular communication application, music/audio application, gaming application, media application, social platform application, and/or any other of the many possible types of various device applications. The device applications 122 utilize images or videos captured by the camera 114 of the mobile device 102. In addition, the device applications 122 can include an associated user interface that is generated and displayed for user interaction and viewing, such as on a display screen of the mobile device 102. An application user interface, or any other type of video, image, graphic, and the like, can represent digital image content that is displayable on the display screen of the mobile device 102.

In the example communication system 100 for contextual camera launching, the mobile device 102 implements the camera launch module 116 (e.g., as a device application, a portion of a communication application, a system functionality, etc.). The camera launch module 116 represents functionality (e.g., logic, software, and/or hardware) enabling techniques for contextual camera launching based on the user environment. The camera launch module 116 can be implemented as computer instructions stored on computer-readable storage media (e.g., the memory 110) and executed by a processor system (e.g., the processor 108) of the mobile device 102. Alternatively, or in addition, the camera launch module 116 is implemented at least partially in the hardware of the mobile device 102. The camera launch module 116 includes the context monitor 118 and the application classifier 120. These components can function cooperatively to monitor the user's environment and improve the user's experience with the camera 114 by detecting the context for camera launching.

The camera 114 is a digital imaging device integrated into the mobile device 102. In some aspects, the camera 114 includes one or more image sensors capable of capturing still images and video content. The mobile device 102 may include multiple cameras, including one or more front-facing and rear-facing cameras. The camera 114 is configurable to operate in various modes, including an “always-on” mode that continuously monitors the device's surroundings. In some implementations, the camera 114 works with the context monitor 118 to provide visual input for determining the current context of the mobile device 102.

The context monitor 118 monitors the environment around the mobile device 102 to detect the context for camera launching. The context monitor 118 uses various sensors 124 to determine the context based on objects in the environment. These sensors 124 can include the camera 114, microphone, and device sensors such as location sensors, accelerometers, and gyroscopes to detect objects and motion near the device. The context monitor 118 also utilizes connected devices like smartwatches or earbuds to gather additional contextual information.

The application classifier 120 uses a machine-learning model to classify applications based on their camera usage patterns and context. The application classifier 120 also uses the machine-learning model to classify objects in an image or video to determine a context. The application classifier 120 works with the context monitor 118 to provide a context-aware camera launching experience.

In accordance with the described techniques, the mobile device 102 includes the camera 114 (e.g., also referred to herein as “camera functionality”) to capture an image of an object. In one implementation, the camera 114 is operable to continuously obtain an image using a rear-facing camera of the mobile device 102 that has an ‘always on’ capability. This allows the context monitor 118 to continuously analyze the environment and determine the context based on objects captured by the camera.

When the mobile device 102 receives a user input to launch the device application 122 associated with the camera, the camera launch module 116 determines the context based on the object captured by the camera or other contextual inputs. The context monitor 118 analyzes the image to identify objects, scenes, or other relevant contextual information. Based on this analysis, the application classifier 120 determines the appropriate device application 122 or functionality of the device application 122 to launch in the current context.

In one or more implementations, the camera launch module 116 launches the device application 122 or device application functionality based on the determined context in response to receiving the user input to launch the application. For example, if the context monitor 118 detects a QR code in the captured image, the application classifier 120 selects to launch a payment application and a payment activity of that device application 122. The camera launch module 116 then launches the payment application directly, bypassing the default camera application.

The communication system 100 provides several advantages over conventional camera launching systems. For example, consider the previous scenario where a user wants to pay using a QR code. With conventional systems, the user manually opens the camera application, scans the QR code, and then switches to the payment application. However, with the described techniques, the camera launch module 116 detects the QR code context and directly launches the payment application and the payment activity when the user initiates a camera launch action. This streamlined process saves time, improves the user's experience, and reduces usage of system resources (e.g., screen output resources, processor resources, etc.).

In another scenario, a user might be at a tourist attraction and want to capture and share a photo on social media quickly. The context monitor 118 detects the scenic environment and determines that a social media application with integrated camera functionality is appropriate for the context. When the user initiates a camera launch, the system automatically opens the social media application's camera interface, allowing immediate capture and sharing. Later in the day, the same user takes a photo of her dinner. In response to the user initiating the camera launch and based on the user's tendency to share food pictures with her friend, the context monitor 118 detects the plate of food and opens the messaging application with integrated camera functionality. This context-aware camera launching enhances user experience and efficiency, addressing challenges that conventional systems often struggle to manage effectively.

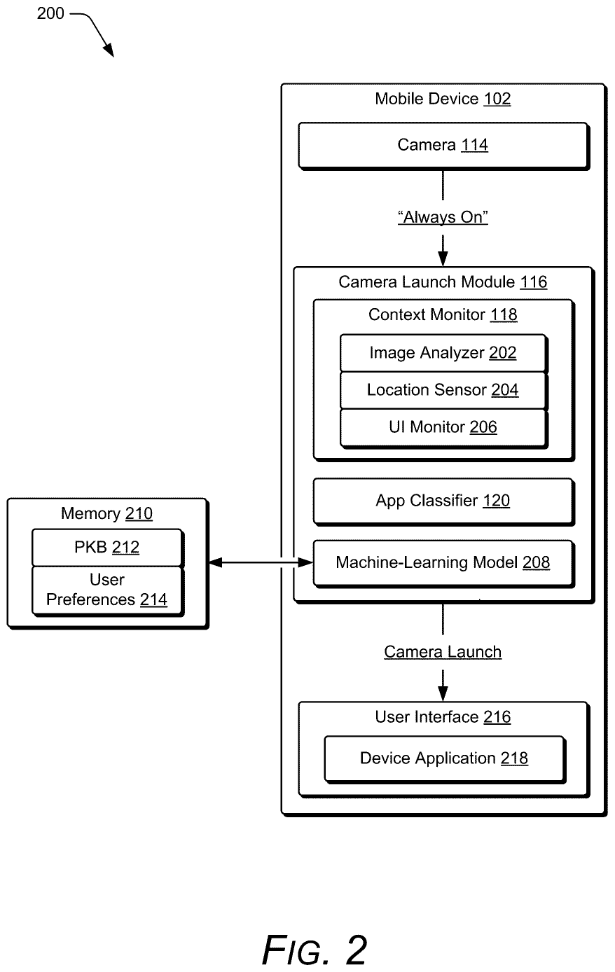

FIG. 2 illustrates an example system 200 in which aspects for contextual camera launching on a mobile device are provided in accordance with one or more implementations as described herein. The example system 200 may implement aspects of the example communication system 100. For example, system 200 can be implemented by a mobile device 102 with one or more cameras 114, the camera launch module 116, the context monitor 118, and the application classifier 120.

In one implementation, the camera 114 is operable to operate in an ‘Always On’ mode, continuously obtaining images using a rear-facing camera of the mobile device 102. The camera 114 connects to a camera launch module 116, which includes the context monitor 118 and the application classifier 120.

The context monitor 118 includes an image analyzer 202, a location sensor 204, and a user interface (UI) monitor 206. These components can function cooperatively to analyze the environment and determine the context for camera launching. The image analyzer 202 processes the images captured by the camera 114, identifying objects, scenes, and other relevant visual information. In one implementation, the context monitor 118 temporarily saves images captured by the camera 114 (e.g., during an “always-on” mode) in a buffer. The temporary storage allows for real-time analysis of the visual context without permanently storing potentially sensitive image data. The image analyzer 202 processes the buffered images to extract relevant contextual information.

The location sensor 204 provides geographical data to add contextual information about the user's surroundings. The location sensor 204 can include various components such as a Global Positioning System (GPS) receiver, Wi-Fi triangulation capabilities, cellular network-based positioning, or an inertial measurement unit (IMU) with accelerometers and gyroscopes, enabling the mobile device 102 to determine its geographical position, altitude, orientation, and movement in different environments.

The UI monitor 206 tracks the current application opened on the device and user interactions with the mobile device 102. In this way, the UI monitor 206 determines or informs the context based on the current application opened on the mobile device 102. This information, combined with the visual context from the image analyzer 202 or location data from the location sensor 204, provides data describing the user's current context and likely intentions for camera use.

The camera launch module 116 also includes the application classifier 120 and a machine-learning model 208. The application classifier 120 functions in conjunction with the machine-learning model 208 to categorize applications based on their camera usage patterns and context. The machine-learning model 208 is trained to classify contexts based on objects captured in images by mobile device cameras and to associate these contexts with camera use by specific applications.

A memory 210 within the system 200 is communicatively coupled to the machine-learning model 208 and includes a personal knowledge base 212 (“PKB”) and user preferences 214. The machine-learning model 208 interacts with the personal knowledge base 212 and user preferences 214 to determine which application to launch based on the detected context. The personal knowledge base 212 represents stored data that includes a collection of user information, including usage patterns associated with images captured by the camera, contacts, and frequently used applications. For instance, the personal knowledge base 212 may include user account details. User preferences 214 include settings and choices made explicitly or implicitly by users regarding camera image usage or default applications to open. For example, user preferences 214 stores configurable settings for the camera launch module 116, such as default or preferred applications for specific contexts, locations, or sequences. The machine-learning model 208 continuously refines its understanding of user behavior and preferences by analyzing patterns in the personal knowledge base 212 and user preferences 214. This adaptive approach allows system 200 to improve its accuracy in predicting the appropriate application to launch based on the detected context over time.

The camera launch module 116 connects to a user interface 216, which includes a user interface associated with a launched device application 218. The user interface 216 receives camera launch signals from the camera launch module 116, allowing for seamless integration of the contextual camera launching functionality into the user experience. A user interface 216 provides an interface for user interaction with the obtained image or video and the device application 218. The user interface 216 also displays appropriate information or interactive elements based on the device application 218 and the obtained image data by the camera 114. The user interface 216 serves as a means of interaction between the device application 218, the image data, and the user.

In one implementation, the system 200 implements a set period to providing learning for the machine-learning model 208 on the mobile device 102 for application invocation leveraging the camera 114 in a service mode. During this learning period, as the user launches new applications, the system classifies each application to a particular image type or context depending on how the camera is invoked from each application. The application classifier 120 maintains this classification information, excluding applications that do not invoke the camera in a service mode from the application classification list. In an additional or alternative implementation, the machine-learning model 208 is pre-trained, and the learning period is used to fine-tune or optimize the camera launching to specific users.

The system 200 can apply the same classification process to quickly open the relevant device application 218 or device application functionality based on the detected context, even if the user is within the default camera application. This functionality extends the contextual launching capabilities beyond just the initial camera invocation.

When a user initiates a camera launch action in one or more implementations, the context monitor 118 quickly analyzes the current environment using data from image analyzer 202, location sensor 204, and/or UI monitor 206. The application classifier 120 and/or the machine-learning model 208 then uses this contextual information and historical data from the personal knowledge base 212 and user preferences 214 to determine the device application 218 or device application functionality to launch. The camera launch module 116 then signals the user interface 216 to launch the selected device application 218, bypassing the default camera application if a more contextually relevant application is identified. This process occurs seamlessly, providing users immediate access to the appropriate camera functionality for their current context. Additionally, or alternatively, system 200 can launch multiple device applications based on the determined context, sharing the captured image or video between the launched applications. This functionality allows for more complex use cases where the visual data is relevant to multiple applications simultaneously.

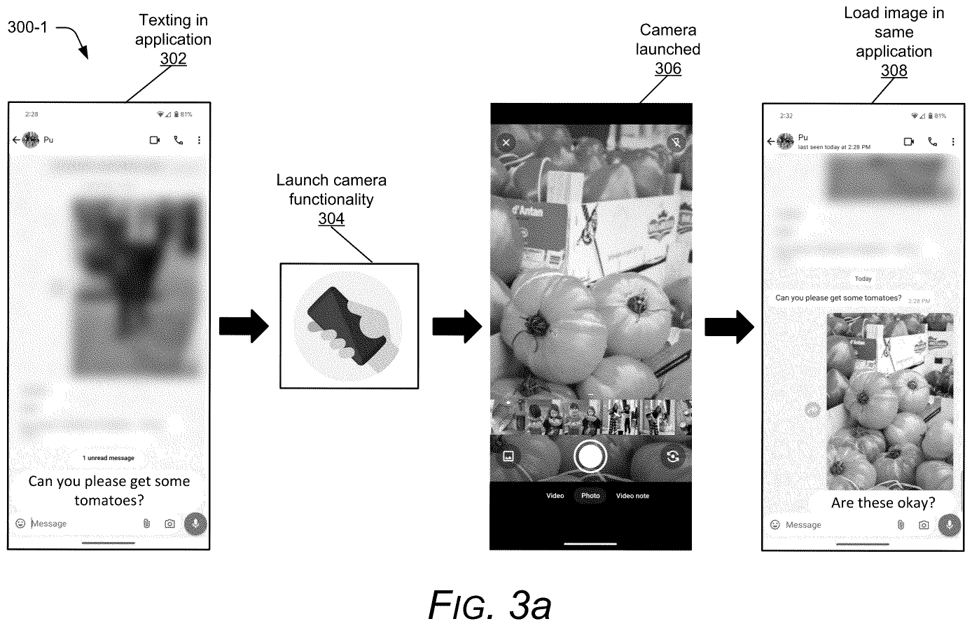

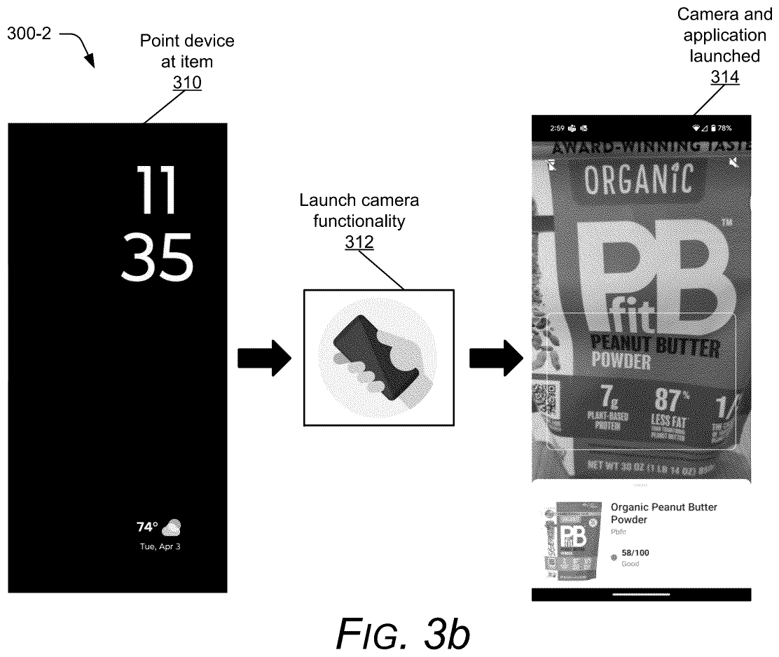

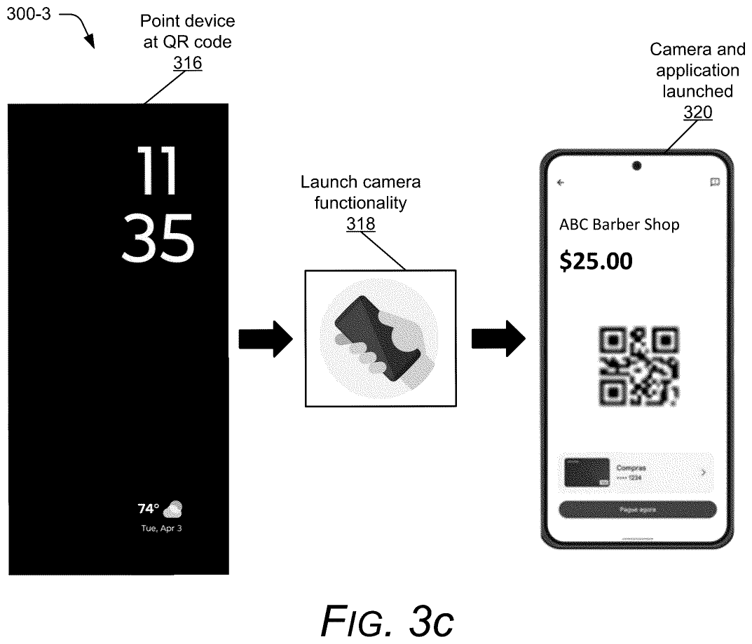

FIG. 3a illustrates an example launch procedure 300-1 for contextual camera launching within a messaging application. The launch procedure 300-1 includes a sequence of interactions demonstrating the launch process and utilizing the camera functionality based on the context of an active messaging conversation.

The launch procedure 300-1 begins with a user messaging a family member via a messaging application (block 302). The interface shows an ongoing conversation where a message requests, “Can you please get some tomatoes?” In this scenario, the messaging application represents the currently active application, which the context monitor 118 uses to determine the context for camera launching.

Following the initial message, the user launches the camera functionality (block 304). The camera launch is triggered by user input, such as a gesture detected by the device sensors 624 or a user interface interaction detected by the UI monitor 206. The camera launch module 116 receives this input and processes it with the contextual information provided by the context monitor 118.

The camera functionality is launched directly within the messaging application interface (block 306). The camera interface appears with options for photo, video, and video note capture, allowing the user to select the appropriate mode for their response. Finally, a captured image is loaded into the messaging application interface (block 308). Launch procedure 300-1 allows the user to bypass the default camera application and instead launch the camera functionality directly within the messaging interface.

In one or more implementations, the camera launch module 116 utilizes data from the personal knowledge base 212 and user preferences 214 stored in memory 210 to refine the camera launching behavior further. For example, if the user frequently responds to requests for groceries within this particular messaging application, the system learns to prioritize in-app camera launching for similar contexts in the future.

Throughout launch procedure 300-1, interface module 112 facilitates the smooth transition between different application states, ensuring the user experience remains cohesive and intuitive. The user interface 216 renders the various interface elements, from the initial conversation view to the in-app camera interface and the final image-embedded response.

FIG. 3b illustrates an example launch procedure 300-2 for contextually launching a device application based on detected items. First, the mobile device 102 displays a locked phone screen and the mobile device 102 is directed at an item (block 310). In the background, the context monitor 118 continuously or periodically analyzes images captured by the camera 114, even when the device is locked. The active context monitoring allows the system 200 to detect and respond to relevant visual cues in the environment without requiring explicit user interaction.

Following the initial locked screen state, the user launches the camera functionality (block 312). In response to receiving the camera launch, the image analyzer 202 processes one or more images captured by the camera 114 to identify objects, text, or other visual elements present in the scene. The camera functionality and a specific application 218 (e.g., a nutrition application) are launched based on the detected context (block 314). In this example scenario, the image analyzer 202 has identified organic peanut butter powder in the captured image. The application classifier 120 works with machine-learning model 208 to determine the appropriate application and application activity to launch based on this visual context. In particular, the image analyzer 202 analyzes the image to extract relevant information about the detected item for context analysis. The camera launch module 116 launches a nutrition and product information application, displaying a screen with details about the organic peanut butter powder. The launched application shows a nutritional score of 58/100 for the product and other relevant information.

The camera launch module 116 coordinates with the user interface 216 to seamlessly transition from the locked screen to a specific activity of the launched application. This process involves unlocking the device, activating the camera functionality, and initializing the selected application 218 with the extracted product information. The display system renders the application interface, showing the product details and nutritional score.

The context monitor 118 considers multiple factors when determining the context for camera launching. In addition to the visual information processed by the image analyzer 202, the location sensor 204 provides geographical data that adds contextual information about the user's surroundings. For instance, if the user is in a grocery store, this location data further supports the decision to launch a nutrition information application.

The UI monitor 206 tracks the user's interactions with the mobile device 102, providing additional context for the camera launch decision. If the user was recently browsing recipes or shopping lists, this information influences the selection of the relevant application to launch when scanning food products.

Additionally, or alternatively, the launch procedure 300-2 includes functionality to share the captured image or extracted product information between multiple launched applications. For instance, while the primary context leads to launching the nutrition information application, the system recognizes that the product details are relevant to a shopping list application or a messaging application. In such cases, the camera launch module 116 initiates a process to share the captured content with these secondary applications, enhancing the overall utility of the contextual camera launch.

FIG. 3c illustrates an example procedure 300-3 for contextual camera activation based on QR code detection. To begin, the mobile device 102 displays a locked phone screen and the user points the mobile device 102 at a QR code (block 316). The context monitor 118 continuously analyzes images captured by the camera 114, enabling the system 200 to detect and respond to QR codes in the environment, which allows the mobile device 102 to initiate the contextual camera launch process without requiring explicit user interaction to open a QR code scanning application.

Following the initial locked screen state, the user launches the camera functionality (block 318). In response to detecting a QR code, the camera launch module 116 launches a payment application based on the detected QR code context (block 320). The payment application is automatically launched along with the camera functionality based on the recognition of the QR code. The application classifier 120 works with the machine-learning model 208 to determine the appropriate application to launch based on the decoded QR code information. The camera launch module 116 coordinates with the user interface 216 to seamlessly transition from the QR code detection to the launched application and a payment activity or task within the launched application. This process involves activating the camera functionality, decoding the QR code, and initializing the selected application 218 with the extracted QR code information. The user interface 216 renders the application interface, showing the relevant payment or financial information associated with the scanned QR code.

In one or more implementations, the machine-learning model 208 utilizes data from the personal knowledge base 212 and user preferences 214 stored in memory 210 to refine the application selection process. For example, if the user frequently uses a specific payment application when scanning QR codes in similar contexts, the system learns to prioritize this application for future QR code scans. In addition to the visual information processed by the image analyzer 202, the location sensor 204 provides geographical data that adds contextual information about the user's surroundings. For instance, if the user is in a retail environment, this location data further supports the decision to launch a payment application when a QR code is detected.

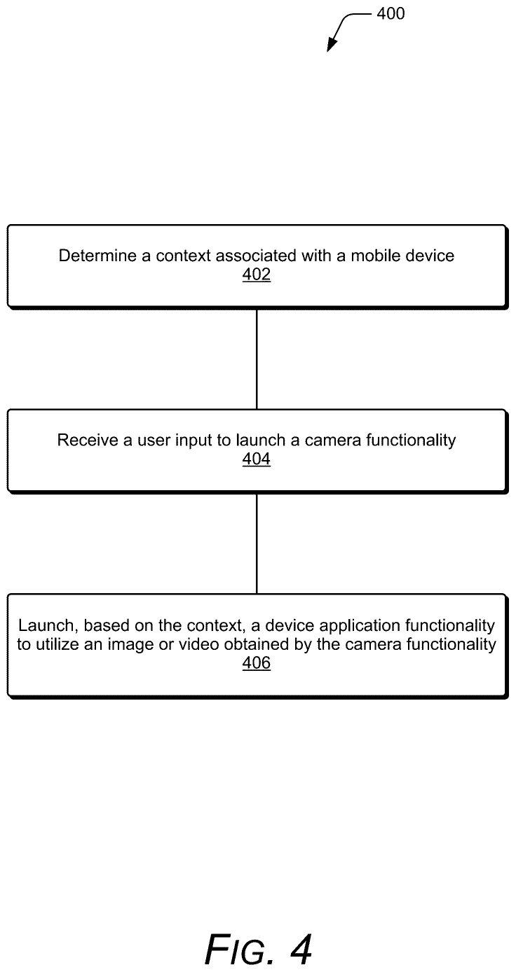

FIG. 4 illustrates an example method 400 for the contextual launching of device applications.

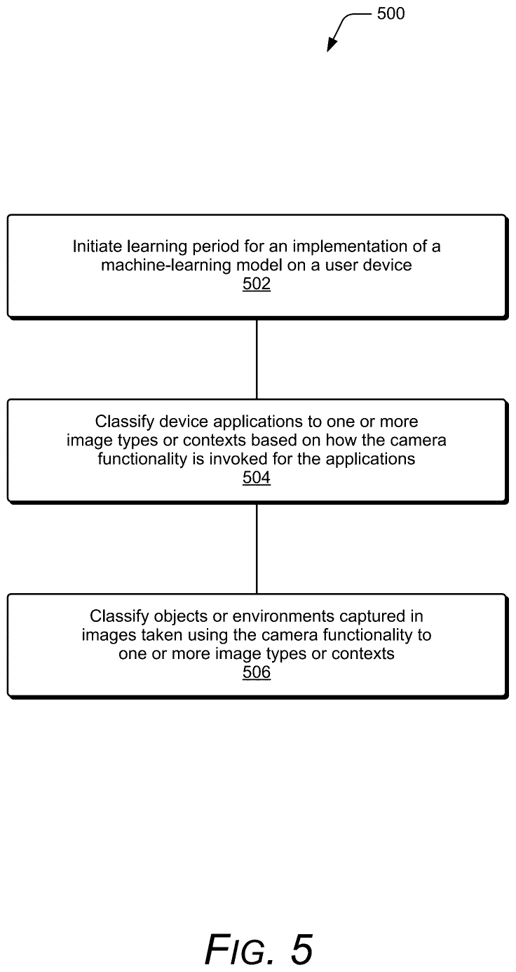

In some aspects, any services, components, modules, methods, and/or operations described herein for FIG. 4 and/or FIG. 5 may be implemented using software, firmware, hardware (e.g., fixed logic circuitry), manual processing, or any combination thereof. Some operations of the example method 400 and/or method 500 may be described in the general context of executable instructions stored on computer-readable storage memory that is local and/or remote to a computer processing system, and implementations may include software applications, programs, functions, and the like. Alternatively, or in addition, any of the functionality described herein may be performed, at least in part, by one or more hardware logic components, such as, and without limitation, field-programmable gate arrays (FPGAs), application-specific integrated circuits (ASICs), application-specific standard products (ASSPs), system-on-a-chip systems (SoCs), complex programmable logic devices (CPLDs), and the like. The order in which method 400 and/or method 500 is described is not intended to be construed as a limitation, and any number or combination of the described operations may be performed in any order to implement the procedure or an alternate procedure.

At block 402, a context associated with a mobile device is determined. For example, the context monitor 118 analyzes various inputs (e.g., sensor data from sensors 124) to determine the user's current environment or context. As described above, the context monitor 118 utilizes multiple information sources to understand the context. The location sensor 204 provides geographical data for the mobile device's current location, providing contextual details about the user's surroundings, such as whether the user is in a retail environment, at home, or in a public space.

In one or more implementations, the context monitor 118 incorporates data from additional sensors to enhance its contextual understanding. Audio sensors like microphones can gather information about the ambient sound environment. The mobile device 102 also detects nearby devices and objects using Bluetooth or other sensors.

The context monitor 118 also accesses calendar information stored in memory 210. This calendar data provides insights into the user's scheduled activities and appointments, contributing to more accurately determining the user's current context. Combining location data, sensor information, and calendar details, the machine-learning model 208 recognizes patterns in the user's behavior and environment that correlate with particular camera-related tasks or applications.

At block 404, a user input to launch a camera functionality of the mobile device is received. For example, the mobile device 102 detects a specific action or gesture from the user indicating an intent to use the camera functionality. The mobile device 102 can recognize a quick double-tap on the power button (or another UI element) or a specific motion pattern as a command to launch the camera functionality. Additionally, or alternatively, the user input includes a user interface interaction such as tapping a camera icon on the home screen, swiping from a locked screen to access the camera functionality or using a voice command to open the camera functionality. The UI monitor 206 tracks these interactions, providing input to the camera launch module 116 about the user's intent to use the camera functionality.

At block 406, a device application functionality to utilize an image or video obtained by the camera functionality is launched based on the context. For example, the camera launch module 116 selects and initializes the appropriate device application (e.g., launches or begins an activity, functionality, or task within the device application) to utilize the image or video obtained by the camera functionality. The application classifier 120 works with the machine-learning model 208 to determine which device application or device application functionality to open or launch for the current context.

The method 400 also incorporates user customization options, allowing users to define specific contexts or application preferences through the user interface 216. These custom settings are stored in the user preferences 214 within memory 210 and are utilized by the machine-learning model 208 when making application launch decisions.

FIG. 5 illustrates an example method 500 for training or optimizing a machine-learning model to implement techniques for contextual launching of device applications in accordance with one or more implementations as described herein.

To begin, a learning period for implementing the machine-learning model is initiated on a user device (e.g., the mobile device 102) (block 502). During this learning period, the camera launch module 116 may collect and analyze data related to camera usage patterns, application behaviors, and user interactions to build a foundation for the techniques described herein. At least a portion of this data is stored in the personal knowledge base 212 and/or the user preferences 214 of memory 210.

The machine-learning model 208 classifies device applications 122 based on how they invoke the camera functionality (block 504). This classification process may analyze various aspects of application behavior, such as the frequency of camera usage, the types of images or videos captured, and the context in which the camera functionality is activated. For example, a social media application may be classified as frequently using the camera for selfies and group photos, while a document scanning application may be associated with capturing text and documents.

The machine-learning model 208 also classifies objects or environments captured in images taken by the camera functionality (e.g., block 506). This classification may involve using computer vision techniques to analyze the content of images and videos, identifying common elements, scenes, or objects that appear in different contexts. The machine-learning model 208 may categorize these visual elements into various types or contexts, such as food items, landscapes, documents, or QR codes. The object classification assists the machine-learning model 208 to associate different visual contents to different device applications or device application functionalities to take when similar content is detected in the future.

By combining the application classification with the image content classification, the machine-learning model 208 learns to associate relationships between camera usage, application functionality, and visual contexts. The described training techniques allows the camera launch module 116 to more accurately predict which applications to launch or actions to take when the camera functionality is invoked in different situations. As the learning continues, the machine-learning model 208 may refine its classifications and predictions, adapting to individual user preferences and evolving usage patterns.

FIG. 6 illustrates various components of an example device 600, which can implement aspects of the techniques and features for contextual camera launching, as described herein. The example device 600 may be implemented as any of the devices described with reference to the previous FIGS. 1-4, such as any type of wireless device, mobile device, mobile phone, flip phone, client device, companion device, display device, tablet, computing, communication, entertainment, gaming, media playback, and/or any other type of computing and/or electronic device. For example, the mobile device 102 described with reference to FIGS. 1-4 may be implemented as the example device 600.

The example device 600 can include various, different communication devices 602 that enable wired and/or wireless communication of device data 604 with other devices. The device data 604 can include any of the various device data and content that is generated, processed, determined, received, stored, and/or communicated from one computing device to another. Generally, the device data 604 can include any form of audio, video, image, graphics, and/or electronic data generated by applications executing on a device. The communication devices 602 can also include transceivers for cellular phone communication and/or for any type of network data communication.

The example device 600 can also include various and different types of data input/output (I/O) interfaces 606, such as data network interfaces that provide connection and/or communication links between the devices, data networks, and other devices. The data I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware that may be accessed by a computing device and that provide persistent storage of data and executable instructions (e.g., software applications, programs, functions, and the like). Examples of memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

Memory devices 612 (e.g., computer-readable storage memory) provide data storage mechanisms, such as storing device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code specific to a particular device, a hardware abstraction layer for a particular device, and so on.

In this example, the device 600 includes a camera launch module 618 that implements various aspects of the features and techniques described herein. The camera launch module 618 may be implemented with hardware components and/or in software as one of the device applications 614, such as when the example device 600 is implemented as the mobile device 102 described with reference to FIGS. 1-4. An example of the camera launch module 618 is the camera launch module 116 implemented by the mobile device 102, such as a software application and/or as hardware components in the mobile device. In implementations, the camera launch module 618 may include independent processing, memory, and logic components as a computing and/or electronic device integrated with the example device 600.

The example device 600 can also include a microphone 620 (e.g., to capture audio and/or an audio recording) and/or camera devices 622 (e.g., to capture digital images and/or video images), as well as device sensors 624, such as may be implemented as components of an inertial measurement unit (IMU). The device sensors 624 may be implemented with various sensors, such as a gyroscope, an accelerometer, and/or other types of motion sensors to sense the motion of the device. The device sensors 624 can generate sensor data vectors having three-dimensional parameters (e.g., rotational vectors in x, y, and z-axis coordinates) indicating the location, position, acceleration, rotational speed, and/or orientation of the device. The example device 600 can also include one or more power sources 626, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system 630 and/or the display system 632 may include any types of devices or modules that generate, process, display, and/or otherwise render audio, video, display, and/or image data. Display data and audio signals may be communicated to an audio component and/or to a display component via any type of audio and/or video connection or data link. In implementations, the audio system 630 and/or the display system 632 are integrated components of the example device 600. Alternatively, the audio system 630 and/or the display system 632 are external, peripheral components to the example device.

Although implementations for real-time user notifications in virtual meetings have been described in language specific to features and/or methods, the appended claims are not necessarily limited to the specific features or methods described. Rather, the specific features and methods are disclosed as example implementations for real-time user notifications in virtual meetings, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device comprising at least one memory and at least one processor coupled with the at least one memory and operable to cause the mobile device to determine a context associated with the mobile device; receive a user input to launch a camera functionality of the mobile device; and launch, based at least in part on the context, a device application functionality to utilize an image or a video obtained by the camera functionality.

A mobile device wherein the context is determined based on at least one of the image or the video captured by the camera functionality, a location of the mobile device, or a currently active device application on the mobile device.

A mobile device wherein the camera functionality is operable to continuously obtain the image or the video using a rear-facing camera of the mobile device.

A mobile device wherein the at least one processor is further operable to cause the mobile device to classify the context using a machine-learning model trained to associate contexts with camera use by specific device applications.

A mobile device wherein the at least one processor is further operable to cause the mobile device to maintain a personal knowledge base of user preferences and historical usage patterns, and utilize, by the machine-learning model, the personal knowledge base in determining which device application functionality to launch based on the context.

A mobile device wherein the at least one processor is further operable to cause the mobile device to receive user feedback on the device application functionality and update the machine-learning model or the personal knowledge base based on the user feedback.

A mobile device wherein the user input comprises a gesture detected by a sensor of the mobile device or a user interface interaction detected by a user interface of the mobile device.

A mobile device wherein the at least one processor is further operable to cause the mobile device to analyze an image captured by the camera functionality to determine the context and select the device application functionality to launch based on objects or text recognized in the image.

A mobile device wherein the device application functionality is operable to process the image or the video to extract information relevant to the device application functionality associated with the context.

A mobile device wherein the at least one processor is further operable to cause the mobile device to detect a QR code in the image or the video captured by the camera functionality and launch the device application functionality associated with the QR code.

A mobile device wherein the at least one processor is further operable to cause the mobile device to launch multiple device applications based on the context and share the image or the video between functionalities of the multiple device applications.

Alternatively, or in addition to the above-described mobile device, any one or combination of:

A method comprising determining a context associated with a mobile device, receiving a user input to launch a camera functionality of the mobile device, and launching, based at least in part on the context, a device application functionality to utilize an image or a video obtained by the camera functionality.

A method wherein the context is determined based on at least one of the image or the video captured by the camera functionality, a location of the mobile device, or a currently active device application on the mobile device.

A method wherein the context is determined using a machine-learning model, the machine-learning model being trained to classify contexts based on objects detected in images and camera used by specific device applications based on the contexts.

A method wherein the machine-learning model is fine-tuned based on receiving indirect user feedback on the device application functionality or receiving a user preference for certain device application functionalities or certain contexts.

A method wherein the user input comprises a gesture detected by a sensor of the mobile device or a user interface interaction detected by another sensor of the mobile device.

Alternatively, or in addition to the above-described mobile device and method, any one or combination of:

A system comprising one or more cameras, at least one memory, and at least one processor coupled with the at least one memory and operable to cause the system to capture, via the one or more cameras, an image of an object, determine a context associated with the system based on the image of the object, and launch a device application functionality based at least in part on the context and in response to receiving a user input to launch a camera functionality associated with the one or more cameras.

A system wherein the image is temporarily saved in a buffer.

A system wherein the at least one processor is further operable to extract information from the image relevant to the device application functionality.

A system wherein the at least one processor is further operable to use a machine-learning model to classify contexts based on objects captured in images by cameras of mobile devices and to associate contexts with camera use by specific device application functionalities, maintain a personal knowledge base of user preferences and historical usage patterns associated with images captured by the system, and utilize, by the machine-learning model, the personal knowledge base in determining which device application or device application functionality to launch based on the context.

1. A mobile device comprising:
at least one memory; and
at least one processor coupled with the at least one memory and operable to cause the mobile device to:
determine a context associated with the mobile device;
receive a user input to launch a camera functionality of the mobile device; and
launch, based at least in part on the context, a device application functionality to utilize an image or a video obtained by the camera functionality.

2. The mobile device of claim 1, wherein the context is determined based on at least one of:
the image or the video captured by the camera functionality;
a location of the mobile device; or
a currently active device application on the mobile device.

3. The mobile device of claim 2, wherein the camera functionality is operable to continuously obtain the image or the video using a rear-facing camera of the mobile device.

4. The mobile device of claim 1, wherein the at least one processor is further operable to cause the mobile device to classify the context using a machine-learning model trained to associate contexts with camera use by specific device applications.

5. The mobile device of claim 4, wherein the at least one processor is further operable to cause the mobile device to:
maintain a personal knowledge base of user preferences and historical usage patterns; and
utilize, by the machine-learning model, the personal knowledge base in determining which device application functionality to launch based on the context.

6. The mobile device of claim 5, wherein the at least one processor is further operable to cause the mobile device to:
receive user feedback on the device application functionality; and
update the machine-learning model or the personal knowledge base based on the user feedback.

7. The mobile device of claim 1, wherein the user input comprises a gesture detected by a sensor of the mobile device or a user interface interaction detected by a user interface of the mobile device.

8. The mobile device of claim 1, wherein the at least one processor is further operable to cause the mobile device to:
analyze an image captured by the camera functionality to determine the context; and
select the device application functionality to launch based on objects or text recognized in the image.

9. The mobile device of claim 1, wherein the device application functionality is operable to process the image or the video to extract information relevant to the device application functionality associated with the context.

10. The mobile device of claim 1, wherein the at least one processor is further operable to cause the mobile device to:
detect a QR code in the image or the video captured by the camera functionality; and
launch the device application functionality associated with the QR code.

11. The mobile device of claim 1, wherein the at least one processor is further operable to cause the mobile device to:
launch multiple device applications based on the context; and
share the image or the video between functionalities of the multiple device applications.

12. A method comprising:
determining a context associated with a mobile device;
receiving a user input to launch a camera functionality of the mobile device; and
launching, based at least in part on the context, a device application functionality to utilize an image or a video obtained by the camera functionality.

13. The method of claim 12, wherein the context is determined based on at least one of:
the image or the video captured by the camera functionality;
a location of the mobile device; or
a currently active device application on the mobile device.

14. The method of claim 12, wherein the context is determined using a machine-learning model, the machine-learning model being trained to classify contexts based on objects detected in images and camera used by specific device applications based on the contexts.

15. The method of claim 14, wherein the machine-learning model is fine-tuned based on receiving indirect user feedback on the device application functionality or receiving a user preference for certain device application functionalities or certain contexts.

16. The method of claim 12, wherein the user input comprises a gesture detected by a sensor of the mobile device or a user interface interaction detected by another sensor of the mobile device.

17. A system comprising:
one or more cameras;
at least one memory; and
at least one processor coupled with the at least one memory and operable to cause the system to:
capture, via the one or more cameras, an image of an object;
determine a context associated with the system based on the image of the object; and
launch a device application functionality based at least in part on the context and in response to receiving a user input to launch a camera functionality associated with the one or more cameras.

18. The system of claim 17, wherein the image is temporarily saved in a buffer.

19. The system of claim 17, wherein the at least one processor is further operable to extract information from the image relevant to the device application functionality.

20. The system of claim 17, wherein the at least one processor is further operable to:
use a machine-learning model to classify contexts based on objects captured in images by cameras of mobile devices and to associate contexts with camera use by specific device application functionalities;
maintain a personal knowledge base of user preferences and historical usage patterns associated with images captured by the system; and
utilize, by the machine-learning model, the personal knowledge base in determining which device application or device application functionality to launch based on the context.
